(19) United States
(12) Patent Application Publication
(10) Pub. No.: US 2008/0149580 A1
(43) Pub. Date: Jun. 26, 2008

(54) Infant feeding tray

(76) Inventor: Diana M. Hill, Center Barnstead, NH (US)

Correspondence Address: LITMAN LAW OFFICES, LTD., P.O. BOX 15035, CRYSTAL CITY STATION, ARLINGTON, VA, 22215, US

(21) Appl. No.: 11/905,730

(22) Filed: Oct. 3, 2007

Related U.S. Application Data
(60) Provisional application No. 60/871,208, filed on Dec. 21, 2006.

(51) Int. Cl. A47B 23/00; A47B 97/00; A47D 3/00; A47J 43/00

(52) U.S. Cl. 211/126.1; 297/153

(57) ABSTRACT

An infant feeding tray prevents an infant from pushing a dish from the eating surface of the tray. The tray includes a dish that is removably locked in an opening in the tray. A cup well is also provided to retain a conventional “sippy” cup therein. The dish is designed with a lip to aid the infant in maneuvering food with a eating utensil. A clamping arrangement permits the tray to be secured to a highchair or to a tabletop. A cover tray having an imperforate surface is disposed over the feeding tray to provide a play surface.

### CROSS-REFERENCE TO RELATED APPLICATION

This application claims the benefit of U.S. Provisional Patent Application Ser. No. 60/871,208 filed Dec. 21, 2006.

### BACKGROUND OF THE INVENTION

1. Field of the Invention

The present invention generally relates to trays. More specifically, the present invention is drawn to an infant feeding tray structure for infants and toddlers.

2. Description of the Related Art

Whether exhibiting joy, throwing a tantrum or merely learning the rudiments of self-feeding, food and receptacles often fly from the table or highchair of an infant or toddler. The ensuing mess (food and receptacles) must then be cleaned up by the parent or caregiver and replacement food provided to ensure that the child receives proper nourishment. The process of cleaning and replacing is both time-consuming and costly. The art would certainly welcome a feeding tray system that would alleviate this process. Thus, an infant feeding tray solving the aforementioned problems is desired.

### SUMMARY OF THE INVENTION

The present invention relates to an infant feeding tray that prevents an infant from pushing a dish from the eating surface of the tray. The tray may include a dish that is removably locked in an opening in the tray. An opening is also provided to retain a conventional “sippy” cup therein. The dish is designed with a lip to aid the infant in maneuvering food with an eating utensil. A clamping arrangement permits the tray to be secured to a highchair or to a tabletop. A cover tray having an imperforate surface is adapted to nest onto the eating tray system to provide a play surface for the infant.

Accordingly, the invention presents an infant feeding tray that prevents an infant from dislodging a dish therefrom and enhances utensil dexterity. The tray is versatile in that it includes a play surface and is easily secured to a highchair or tabletop. The invention provides for improved elements thereof in an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is an environmental, perspective view of an infant feeding tray according to the present invention.

FIG. 2 is a perspective view of an infant feeding tray according to the present invention with the dish removed.

FIG. 3 is a partial view in section of the lip of an infant feeding tray according to the present invention.

FIG. 4 is a bottom view of an infant feeding tray according to the present invention with the dish removed.

FIG. 5 is a perspective view of a dish for an infant feeding tray according to the present invention.

FIG. 6 is a partial side view in section of an infant feeding tray according to the present invention, showing a clamp.

FIG. 7 is a perspective view of an infant feeding tray according to the present invention, showing an optional cover tray exploded from the feeding tray.

Similar reference characters denote corresponding features consistently throughout the attached drawings.

### DETAILED DESCRIPTION OF THE PREFERRED EMBODIMENTS

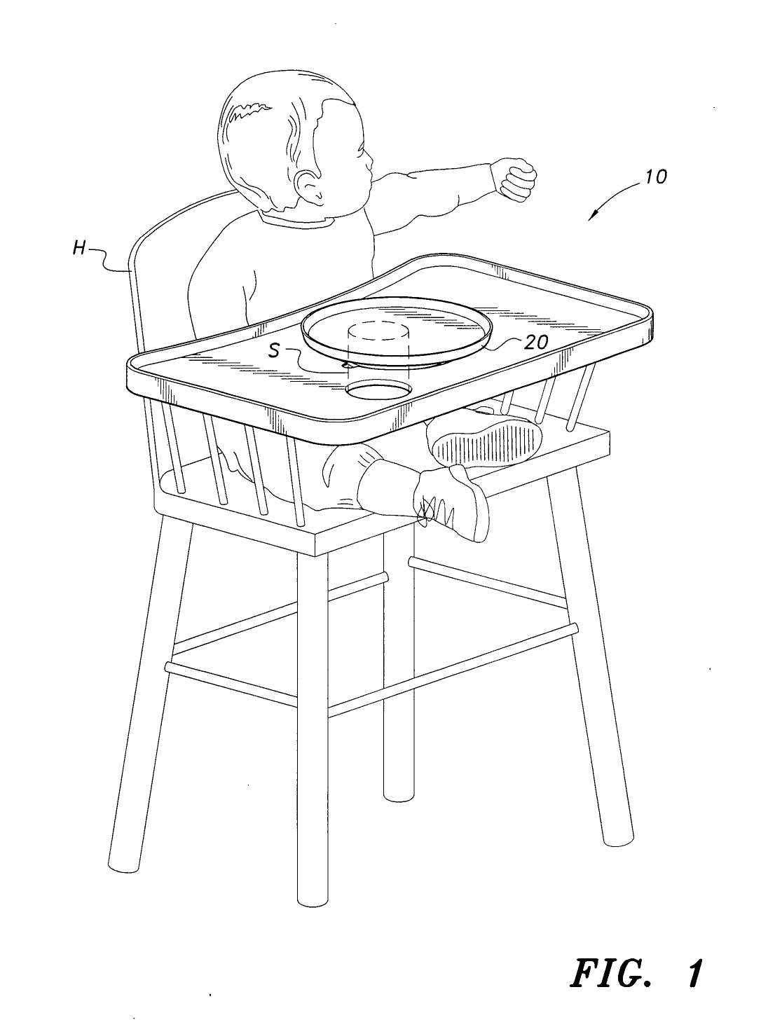

Attention is first directed to FIG. 1, wherein the infant feeding tray of the present invention is generally indicated at 10. As illustrated, feeding tray 10 is removably mounted on a highchair H. It should be recognized however, that tray 10 can also be mounted on a tabletop, if desired. Tray 10 may include a removable dish 20 and a “sippy” cup S, both removably secured in openings in tray 10. The dish 20 may be a bowl or a plate having a raised peripheral lip to prevent food from spilling over the edge of the plate, or the tray 10 may be furnished with interchangeable bowls, plates, or other dishware.

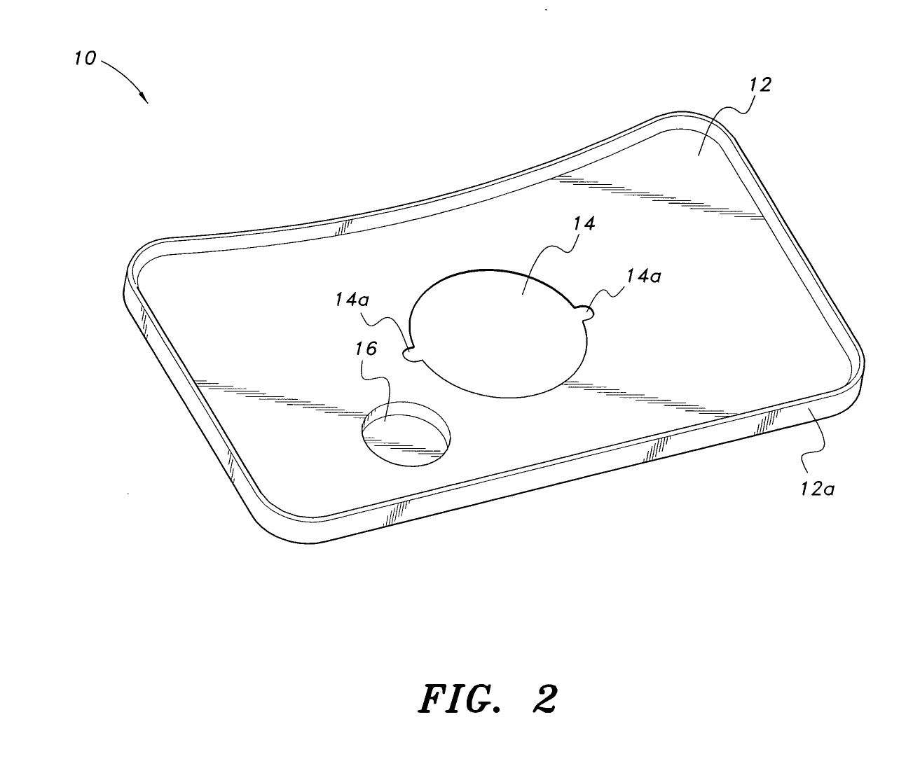

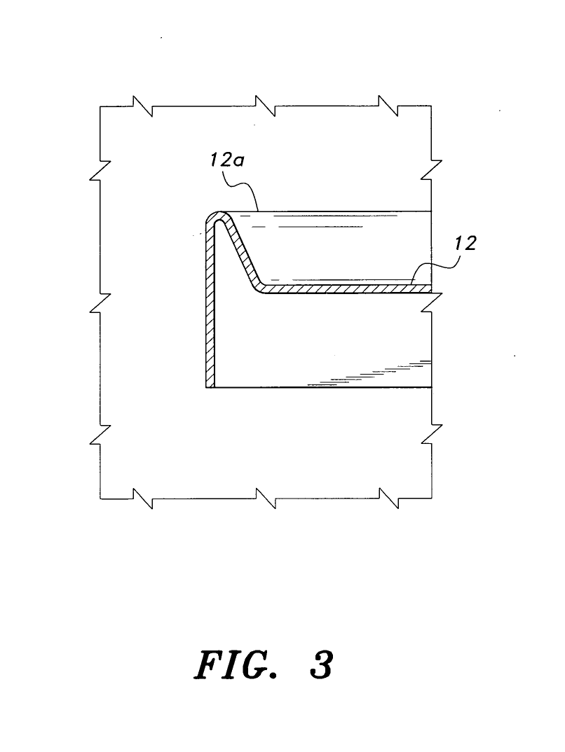

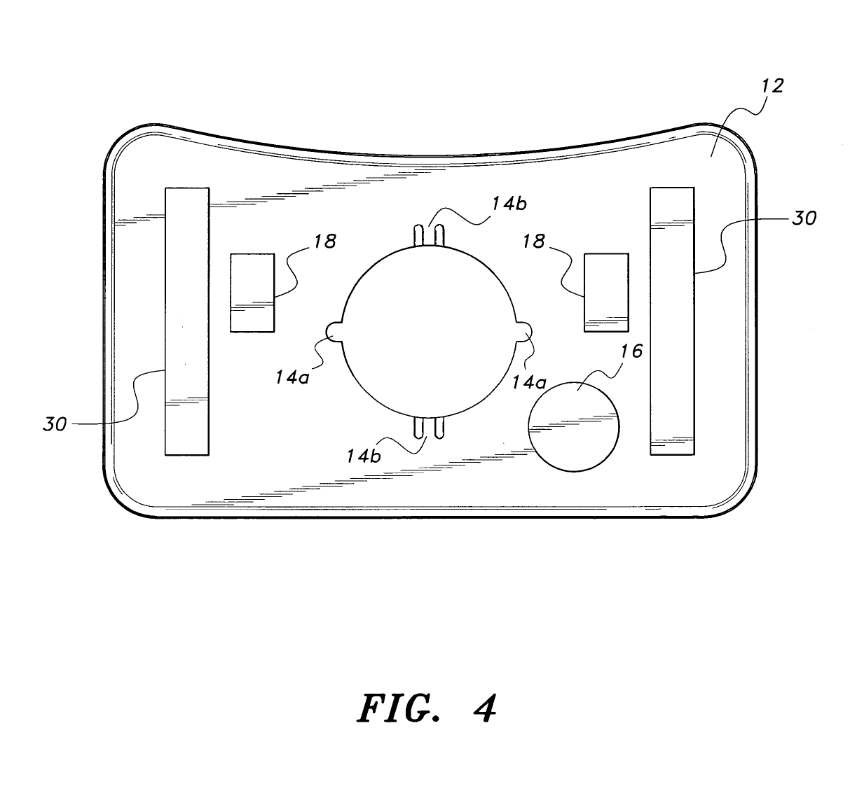

As best seen in FIGS. 2-4, tray 10 comprises a main body 12 having a planar top surface. An upstanding edge 12a extends around the periphery of body 12. Edge 12a functions to retain spills on the planar surface and to prevent such spills from falling to the floor. A dish-retaining aperture 14 is positioned centrally in body 12. Aperture 14 is formed with a pair of diametrically opposed slots 14a. A well 16 is offset from aperture 14. Well 16 may be tapered to frictionally retain a drinking cup or sippy cup S therein, and may measure about 3″ in diameter and 1″ in depth. As shown in FIG. 4, the bottom surface of body 12 (FIG. 4) is provided with conventional slide fittings 18 for removably securing body 12 to the highchair H. Clamping assembly 30 (described below) is used to removably secure body 12 to a tabletop or the like. Two diametrically opposed notches 14b are formed by parallel ridges, bumps, or other projecting members on the bottom surface of body 12, the notches 14b providing keepers. Notches 14b are offset 90° from openings 14a.

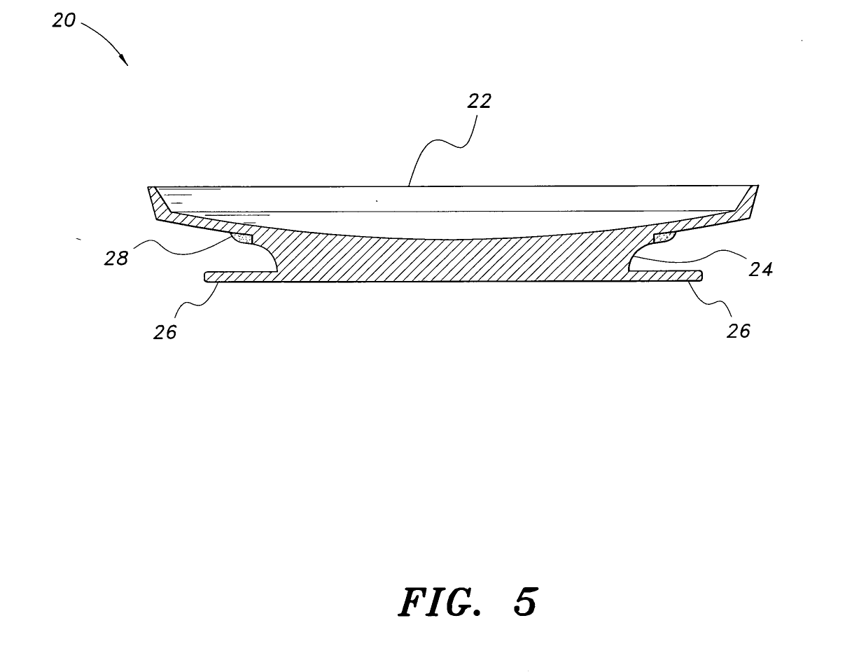

As shown in FIG. 5, dish 20 is designed with a lip 22 extending around the periphery of its upper surface. A base member 24 extends downward from the bottom of dish 20. Two diametrically opposed lugs 26 forming latches are disposed at the lower end of base member 24. A rubber ring 28 interfaces the bottom of dish 20 and the upper end of base member 24. In use, base member 24 is oriented relative to aperture 14 so that lugs 26 are aligned with slots 14a. Base member 24 is then inserted through aperture 14 and dish 20 is rotated 90° so that lugs 26 will engage notches 14b and secure the dish 20 on body 12. Rubber ring 28 permits slight compression during the insertion and rotation process.

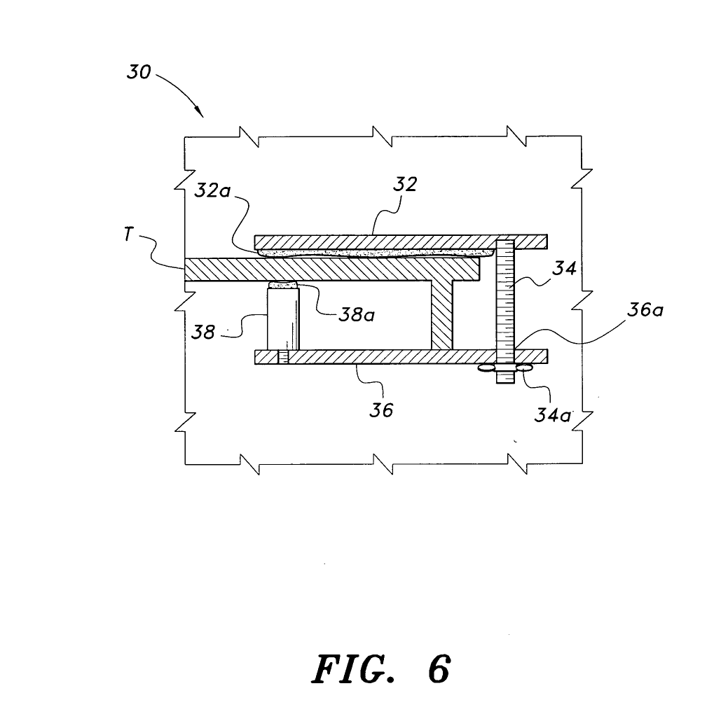

As best seen in FIG. 6, each clamping assembly 30 comprises an upper strip 32 that is molded to or otherwise attached to the bottom surface of body 12. A screw 34 has an upper end removably attached to the bottom surface of strip 32. Screw 34 extends downward from upper strip 32 and has a lower end inserted through an opening 36a formed through clamping strip 36 adjacent a front end thereof. A spacer peg 38 is removably attached adjacent the rear end of lower clamping strip 36. A wing nut 34a is disposed on the lower end of screw 34. Non-skid materials 32a and 38a are respectively disposed on the undersurface of upper strip 32 and the upper end of spacer peg 38. Threading the wing nut 34a up or down allows the clamp assembly 30 to secure tray body 12 to most conventional tabletops T.

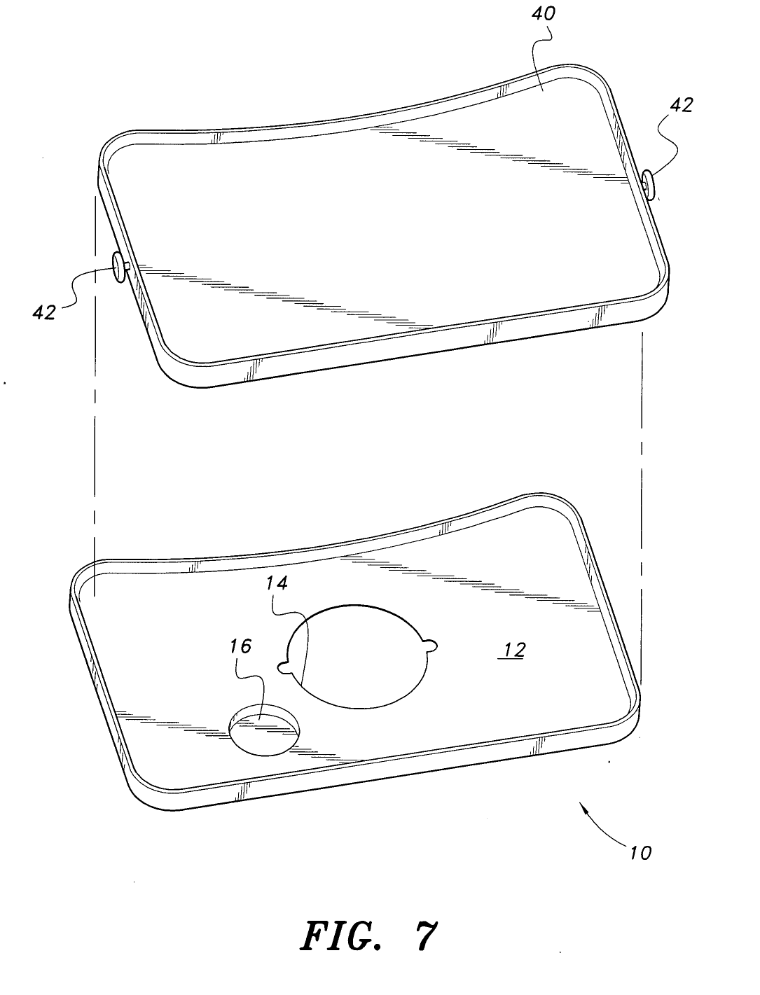

The infant feeding tray 10 may include a cover tray 40, as shown in FIG. 7, that permits conversion of the eating surface to a play surface. Cover tray 40 is coextensive with the configuration of body member 12, but is slightly larger to allow cover tray 40 to fit over body member 12. The upper surface of cover tray 40 is planar and imperforate such that a smooth playing surface is provided. Knobs or handles 42 are disposed on the ends of cover tray 40 to enhance positioning and removal thereof. The cover tray 40 may snap onto the periphery of body member 12 for a secure fit.

It is to be understood that the present invention is not limited to the embodiments described above, but encompasses any and all embodiments within the scope of the following claims.

I claim:

1. An infant feeding tray, comprising:
a body member having an upper planar surface and a bottom surface, the body member having a main aperture formed through the body member at a central area of the upper planar surface;
a drinking cup well formed in the body member and depending from the bottom surface of the body member, the well being offset from the main aperture;
slide fittings disposed on the bottom surface of the body member adapted for removably attaching the body member to a highchair; and
at least one clamp disposed on the bottom surface of the body member adapted for removably attaching the body member to a tabletop.

2. The infant feeding tray according to claim 1, wherein said body member defines a perimeter and further comprises an upstanding rim coextensive with the perimeter.

3. The infant feeding tray according to claim 1, wherein said main body has two pairs of parallel projecting members defining a pair of notches disposed on the bottom surface on diametrically opposed sides of the main aperture, the infant feeding tray further including a dish having a bottom surface and a base member extending from the bottom surface, the base member having diametrically opposed lugs extending therefrom, the base member being insertable through the main aperture, the lugs releasably engaging the notches to form a twist lock securing the dish to said body member when the dish is rotated.

4. The infant feeding tray according to claim 1, further including a drinking cup frictionally retained in said well.

5. The infant feeding tray according to claim 1, further including a cover tray positioned atop said body member, said cover tray having a smooth, planar, imperforate surface.

6. An infant feeding tray, comprising:
a body member having an upper planar surface and a bottom surface, the body member having a main aperture formed through a central area of the upper planar surface;
a dish removably retained in the main aperture, the dish having at least one latch extending therefrom;
at least one keeper disposed on the bottom surface of the body member, the at least one latch engaging the at least one keeper in order to secure the dish in the main aperture;
a drinking cup well formed in the body member, the well being offset from the main aperture;
a drinking cup frictionally retained in the drinking cup well;
means for removably attaching the body member to a highchair; and
means for removably attaching said body member to a tabletop.

7. The infant feeding tray according to claim 6, wherein said body member defines a perimeter and includes an upstanding rim coextensive with the perimeter.

8. The infant feeding tray according to claim 6, wherein said dish has an upper surface and an upstanding lip extending around the upper surface of the dish.

9. The infant feeding tray according to claim 6, wherein said dish has an upper surface and a bottom surface, said main body having two pairs of parallel projecting members defining a pair of notches disposed on the bottom surface of said body member on diametrically opposed sides of the main aperture, the dish having a base member extending from the bottom surface, the base member having diametrically opposed lugs extending therefrom, the base member being insertable through the main aperture, the lugs releasably engaging the notches to form a twist lock securing the dish to said body member when the dish is rotated.

10. The infant feeding tray according to claim 6, wherein said means for removably attaching said body member to a tabletop includes a pair of adjustable clamping members disposed on the bottom surface of said body member.

11. The infant feeding tray according to claim 6, further including a cover tray positioned atop said body member, the cover tray being substantially coextensive with said body member and having a smooth, planar, imperforate surface.

12. The infant feeding tray according to claim 11, wherein said cover tray has a pair of ends, the cover tray having a handle disposed on each of the ends, respectively.

13. An infant feeding tray, comprising:
a body member having an upper planar surface and a bottom surface, the body member defining a perimeter;
an upstanding rim coextensive with the perimeter of the body member;
a main aperture formed through a central area of the upper planar surface of the body member;
a dish having an upper surface and a bottom surface;
an upstanding lip extending around the upper surface of the dish;
means for securing the dish in the main aperture;
a drinking cup well formed in the body member and extending from the bottom surface of the body member, the well being offset from the main aperture;
a drinking cup frictionally retained in the drinking cup well;
means for removably attaching the body member to a highchair; and
means for removably attaching the body member to a tabletop.

14. The infant feeding tray according to claim 13, wherein said body member has a keeper disposed on the bottom surface thereof, said dish having a base member extending from the bottom surface of said dish, the base member having an upper end and a lower end and at least one lug extending from the lower end of the base member, the lug engaging the keeper for securing said dish to the main aperture the base member further including a rubber ring interfacing the upper end of the base member and the bottom surface of said dish.

15. The infant feeding tray according to claim 13, wherein said means for removably attaching said body member to a tabletop comprises a pair of adjustable clamping members disposed on the bottom surface of said body member, each of the clamping members having a respective spacer peg removably mounted thereon.

16. The infant feeding tray according to claim 15, further including a cover tray positioned atop said body member, the cover tray being substantially coextensive with said body member and having a smooth, planar, imperforate surface.

17. The infant feeding tray according to claim 16, wherein said cover tray has a pair of ends and a handle disposed on each of the ends.
